(19) United States
(12) Patent Application Publication
(10) Pub. No.: US 2020/0117495 A1
(43) Pub. Date: Apr. 16, 2020

(54) ZONE COMPUTE AND CONTROL ARCHITECTURE

(71) Applicant: GM Global Technology Operations LLC, Detroit, MI (US)

(72) Inventors: Soheil Samii, Royal Oak, MI (US); Asher Waldfogel, Palo Alto, CA (US); Massimo Osella, Troy, MI (US); Fan Bai, Ann Arbor, MI (US)

(21) Appl. No.: 16/587,746

(22) Filed: Sep. 30, 2019

Related U.S. Application Data
(60) Provisional application No. 62/745,780, filed on Oct. 15, 2018.

(51) Int. Cl. G06F 9/455; G06F 9/50

(52) U.S. Cl. CPC G06F 9/45558; G06F 9/5005; G06F 2009/45595; G06F 2009/45579; G06F 9/5083

(57) ABSTRACT

A method of zone controlling of features and functions of a vehicle is provided. The zone controlling includes a backbone, which is communicatively coupled to a connected compute center and zone modules, communicating inputs and outputs with respect to the features and the functions. The connected compute center host processing operations that control the features and the functions of the vehicle based on the inputs and outputs communicated via the backbone. The zone modules distribute the inputs and outputs to and from the features and the functions of the vehicle.

### CROSS REFERENCE TO RELATED APPLICATION

This application claims the benefit of U.S. Provisional Patent Application Ser. No. 62/745,780 filed Oct. 15, 2018 which is incorporated herein by reference in its entirety.

### BACKGROUND

In general, conventional automotive electrical architectures comprise a significant number of microprocessors, essentially one per function/feature. This approach has led to large and difficult to manage wiring complexities, mass, space requirements, and cost.

### SUMMARY

According to one or more embodiments, a method of zone controlling of features and functions of a vehicle is provided. The zone controlling includes a backbone, which is communicatively coupled to a connected compute center and zone modules, communicating inputs and outputs with respect to the features and the functions. The connected compute center host processing operations that control the features and the functions of the vehicle based on the inputs and outputs communicated via the backbone. The zone modules distribute the inputs and outputs to and from the features and the functions of the vehicle.

According to one or more embodiments or the method embodiment above, the features and the functions can include input/output devices distributed throughout the vehicle and connected to the one or more zone modules based on a region of the vehicle.

According to one or more embodiments or any of the method embodiments above, the one or more zone modules can support different domains of the features and the functions.

According to one or more embodiments or any of the method embodiments above, the connected compute center can execute a virtual platform including one or more virtual machines that operate the features and the functions of the vehicle by driving the inputs and outputs across the backbone and through the one or more zone modules.

According to one or more embodiments or any of the method embodiments above, the backbone can include an Ethernet backbone providing local area and wide area network capabilities for communicating the inputs and the outputs between at least the connected compute center and the one or more zone modules.

According to one or more embodiments or any of the method embodiments above, the connected compute center can be communicatively coupled to a cloud service where certain functions are offloaded from the connected compute center to remote compute resources therein.

According to one or more embodiments or any of the method embodiments above, the features and the functions can include transducers, lights, light emitting diodes, or speakers.

According to one or more embodiments, a system for zone controlling of features and functions of a vehicle is provided. The system includes a backbone communicatively coupled to a connected compute center and one or more zone modules. The backbone communicates inputs and outputs with respect to the features and the functions. The system includes the connected compute center that hosts processing operations that control the features and the functions of the vehicle based on the inputs and outputs communicated via the backbone. The system includes the one or more zone modules that distribute the inputs and outputs to and from the features and the functions of the vehicle.

According to one or more embodiments or the system embodiment above, the features and the functions can include input/output devices distributed throughout the vehicle and connected to the one or more zone modules based on a region of the vehicle.

According to one or more embodiments or any of the system embodiments above, the one or more zone modules can support different domains of the features and the functions.

According to one or more embodiments or any of the system embodiments above, the connected compute center can execute a virtual platform including one or more virtual machines that operate the features and the functions of the vehicle by driving the inputs and outputs across the backbone and through the one or more zone modules.

According to one or more embodiments or any of the system embodiments above, the backbone can include an Ethernet backbone providing local area and wide area network capabilities for communicating the inputs and the outputs between at least the connected compute center and the one or more zone modules.

According to one or more embodiments or any of the system embodiments above, the connected compute center can be communicatively coupled to a cloud service where certain functions are offloaded from the connected compute center to remote compute resources therein.

According to one or more embodiments or any of the system embodiments above, the features and the functions can include transducers, lights, light emitting diodes, or speakers.

According to one or more embodiments, a vehicle providing zone control of features and functions is provided. The vehicle includes a backbone communicatively coupled to a connected compute center and one or more zone modules. The backbone communicates inputs and outputs with respect to the features and the functions. The system includes the connected compute center that hosts processing operations that control the features and the functions of the vehicle based on the inputs and outputs communicated via the backbone. The system includes the one or more zone modules that distribute the inputs and outputs to and from the features and the functions of the vehicle.

According to one or more embodiments or the vehicle embodiment above, the features and the functions can include input/output devices distributed throughout the vehicle and connected to the one or more zone modules based on a region of the vehicle.

According to one or more embodiments or any of the vehicle embodiments above, the one or more zone modules can support different domains of the features and the functions.

According to one or more embodiments or any of the vehicle embodiments above, the connected compute center can execute a virtual platform including one or more virtual machines that operate the features and the functions of the vehicle by driving the inputs and outputs across the backbone and through the one or more zone modules.

According to one or more embodiments or any of the vehicle embodiments above, the backbone can include an Ethernet backbone providing local area and wide area network capabilities for communicating the inputs and the outputs between at least the connected compute center and the one or more zone modules.

According to one or more embodiments or any of the vehicle embodiments above, the connected compute center can be communicatively coupled to a cloud service where certain functions are offloaded from the connected compute center to remote compute resources therein.

According to one or more embodiments or any of the vehicle embodiments above, the features and the functions can include transducers, lights, light emitting diodes, or speakers.

According to one or more embodiments, the above method, vehicle, and system can be implemented as a platform, an architecture, and/or computer program product.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a system in accordance with one or more embodiments;

FIG. 2 depicts a process flow in accordance with one or more embodiments;

FIG. 3 depicts an architecture in accordance with one or more embodiments; and

FIG. 4 depicts a process flow in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

Turning now to an overview, one or more embodiments address the herein-described shortcomings of the conventional automotive electrical architectures by a fundamental re-architecture of electrical content of a vehicle through an application of zone and compute controllers. In accordance with one or more embodiments, this fundamental re-architecture can be implemented as a system, a platform, a method, and/or computer program product (collectively referenced herein as a system for brevity). For example, the system provides an approach for wiring of input/output (I/O) devices across the vehicle by using an application of an Ethernet backbone to gate I/O zone controllers to and from a connected compute controllers. The system, thus, provides an automotive electrical architecture concept that moves away from conventional automotive electrical architectures; provides an application of zone controllers to distribute I/O to features and functions of vehicle; provides an application of connected compute controllers to host a variety of vehicle functions/features, and provides an application of cloud computing to host certain vehicle functions and features that can afford any wireless communication latency to the vehicle.

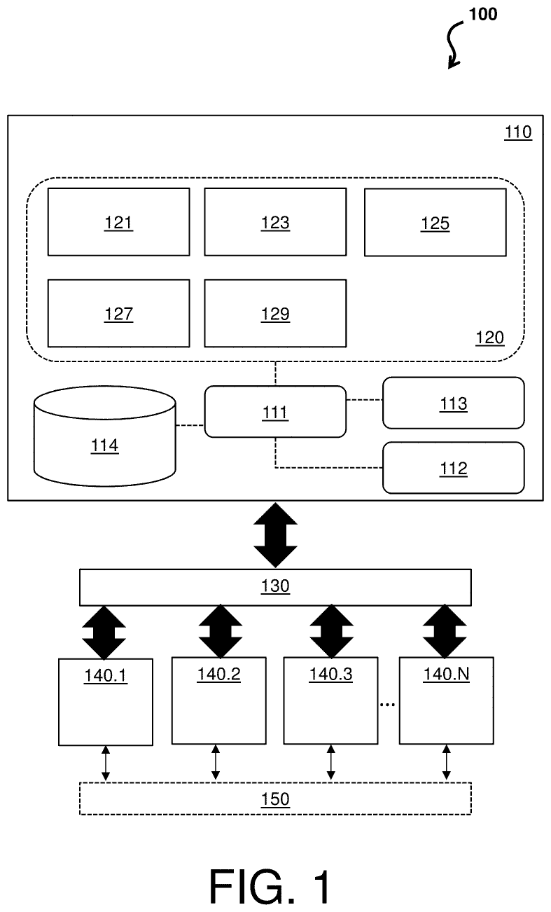

Turning now to FIG. 1, a system 100 in accordance with one or more embodiments is provided. The system 100 can be an electronic, computer framework comprising and/or employing any number and combination of computing device and networks utilizing various communication technologies, as described herein. The system 100 can be easily scalable, extensible, and modular, with the ability to change to different services or reconfigure some features independently of others. In accordance with one or more embodiments, the system 100 is implemented across a vehicle (e.g., a machine used to transports people or cargo). Examples of vehicles include, but are not limited to, motor vehicles (e.g., motorcycles, cars, trucks, and buses), railed vehicles (e.g., trains and trams), watercraft (e.g., ships and boats), and aircraft (e.g., airplanes and helicopters).

In general, the system 100 provides electrical and software architecture for vehicle applications, leveraging modern wired/wireless communication and embedded/cloud computing technologies. As shown in FIG. 1, the system 100 includes a connected compute center 110, which includes a processor 111, a system memory 112, an accelerator 113, and a database 114, each of which support the operations of a virtual platform 120. The virtual platform 120 includes a braking virtual machine 121, a body virtual machine 123, a lighting virtual machine 125, a steering virtual machine 127, and an active safety virtual machine 129. Note that while virtual machines are utilized to indicate that different software executes on the system 100, other software structures are contemplated, such as containers (e.g., via Linux) or partitions (e.g., an operating system that provides temporal and spatial isolation among partitions). The system 100 includes a backbone 130, one or more zone I/O controllers 140.1, 140.2, 140.3 . . . 140.N (collectively referred to as zone I/O controllers 140), and I/O devices represented as dashed-block 150. The connected compute center 110 is communicatively coupled via the backbone 130 to the zone I/O controllers 140 (and vice versa), which further communicate to the one or more I/O devices.

The connected compute center 110 is a computing device and an example of a connected compute controller (also called compute controllers) that supports mixed I/O from different (e.g., separate and/or independent) domains and functions across the zone I/O controllers 140. The connected compute center 110 can comprise one or more compute modules, which are connected to the same backbone 130 as the zone controllers. In turn, a physical separation among domains of the system 100 are no longer separate, as virtual machines and applications from different domains execute on the same connected compute center 110. For instance, the connected compute center 110 supports a mixed environment in terms of software functions. The connected compute center 110 can include one or more adapters (e.g., hard disk controllers, network adapters, graphics adapters, etc.) that interconnect and support communications between the processor 111, the system memory 112, the database 114, and other components of the system 100 (e.g., peripheral devices on the backbone 130). In one or more embodiments, the one or more adapters can be connected to one or more I/O buses that are connected to the system bus via an intermediate bus bridge, and the one or more I/O buses can utilize common protocols, such as the Peripheral Component Interconnect (PCI).

The processor 111, which can include one or more central processing units (CPUs), can be referred to as a processing circuit, microprocessor, or computing unit that is coupled via a system bus to a system memory 112 and various other components. The system memory 112 can include read-only memory (ROM) and random access memory (RAM). The ROM is coupled to the system bus and may include a basic input/output system (BIOS), which controls certain basic functions of the system 100. The RAM is read-write memory coupled to the system bus for use by the processor 111. The accelerator 113 is an example of a specialized processor (e.g., the processor 111), such as a graphics processing unit or the like.

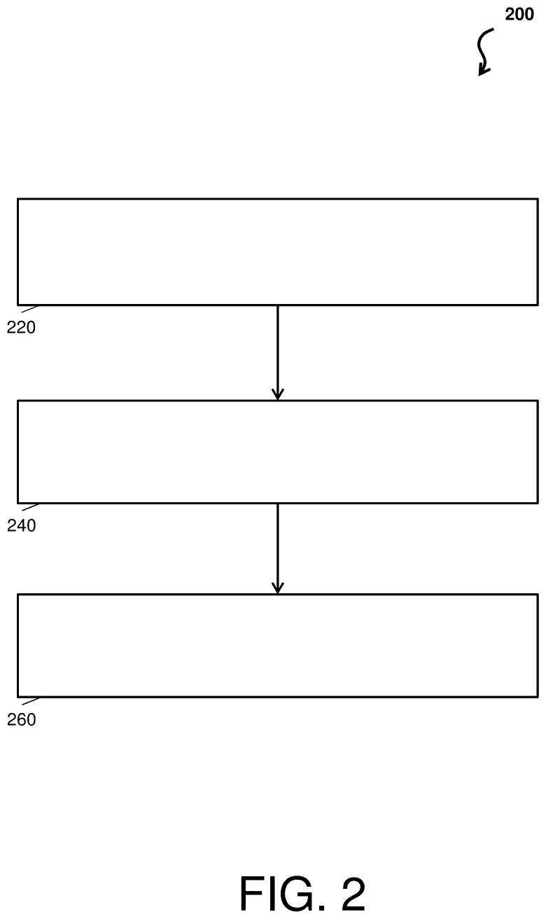

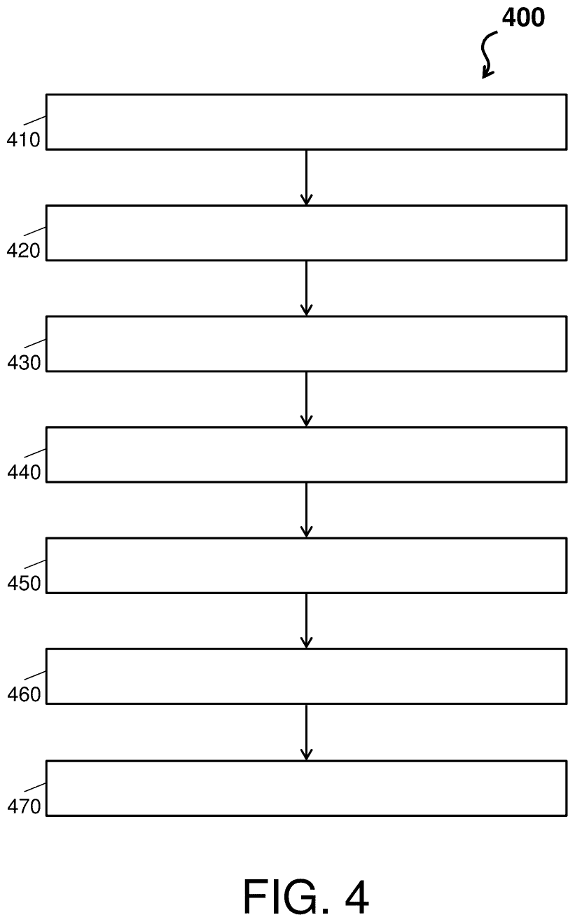

The database 114 is an example of a tangible storage medium readable/executable by the processor 111. The database 114 stores software and data. The software is stored as instructions for execution on the system 100 by the processor 111 (to perform process, such as the process flows 200 and 400 of FIGS. 2 and 4, respectively). The data includes a set of values of qualitative or quantitative variables organized in various data structures to support and be used by operations of the software. Note that the software and the data can be distributed across other controllers, as well as remote compute resources (e.g., a cloud service that is utilized to offload certain functions from the vehicle to a remote compute resource).

The virtual platform 120 is a simulated hosting environment executed by the connected compute center 110 to support operations of virtual machines therein. A virtual machine is an emulation of a computer system or architecture that provides functionality through specialized software. The braking virtual machine 121 is an example of a virtual machine for managing/implementing braking operations of the vehicle, along with associated I/O braking devices (e.g., brake actuators, speed sensors, and the like of a vehicle). The body virtual machine 123 is an example of a virtual machine for managing/implementing body operations of the vehicle, along with associated I/O body devices (e.g., doors, windows, trunk, hood, mirrors, and the like of a vehicle). The lighting virtual machine 125 is an example of a virtual machine for managing/implementing lighting operations of the vehicle, along with associated I/O lighting devices (e.g., head lights, floor lights, fog lights, brake lights, dashboard lighting, and the like of a vehicle). The steering virtual machine 127 is an example of a virtual machine for managing/implementing steering operations of the vehicle, along with associated I/O steering devices (e.g., steering column, steering position sensors, steering relays, and the like of a vehicle). The active safety virtual machine 129 is an example of a virtual machine for managing/implementing active safety operations of the vehicle, along with associated I/O active safety devices (e.g., seat belt sensors, seat belt retractors, airbags, and the like of a vehicle).

The backbone 130 is a network infrastructure including wired and wireless connection mediums that support communications between the connected compute center 110 and the zone I/O controllers 140. In accordance with one or more embodiments, the backbone 130 can be an Ethernet backbone providing local area network (LAN) and wide area network (WAN) capabilities for the communications of the system 100. The Ethernet backbone can be a one Gigabits per second network that enables seamless transmissions of I/Os around the system 100.

The zone I/O controllers 140 can be chips, computing cards, or stand-alone devices (thereby including at least a processor and a memory) that interface with a peripheral devices, such as the I/O devices discussed herein. Examples of the zone I/O controllers 140 include gate I/O zone modules (also called a zone gateway or a zone module) that provide different domains and functions for the I/O devices. The zone I/O controllers 140 are connected to the backbone 130. The zone I/O controllers 140 make inputs and outputs available to the virtual machines and the applications executing on the connected compute center 110. In accordance with one or more embodiments, the zone I/O controllers 140 can support and host, via the backbone, a wide range of vehicular functions of mixed criticality. For instance, zone I/O controllers 140 provide a gating function (e.g., a main communication interface) for data communicated to and from the I/O devices, along diagnostic and time synchronization operations.

The I/O devices (represented by dashed-block 150) include functions and/or features of the vehicle, which are managed and operated by one or more virtual machines of the the virtual platform 120 (e.g., the virtual platform 120 as executed by the connected compute center 110 support operations of the I/O devices by driving I/O across the backbone 101 and through the zone I/O controllers 140). In practice, the I/O devices include transducers that convert variations in a physical quantity, such as speed or pressure, into an electrical signal or vice versa. Further, the I/O devices can also be output devices such as lights, light emitting diodes, speakers. The I/O devices can also communicate via any interface, such as a controller area network (CAN), a local interconnect network (LIN), a direct I/O interface, an analog to digital (A/D) interface, a digital to analog (D/A) interface, or any other interface specific to the input/output. Each I/O device is connected to a zone I/O controller 140 based on proximity to that zone I/O controllers 140, regardless of the interface used by that I/O.

As described herein, examples of the I/O devices include I/O braking devices (e.g., brake actuators, speed sensors, and the like of a vehicle). I/O body devices (e.g., doors, windows, trunk, hood, mirrors, and the like of a vehicle). I/O lighting devices (e.g., head lights, floor lights, fog lights, brake lights, dashboard lighting, and the like of a vehicle); I/O steering devices (e.g., steering column, steering position sensors, steering relays, and the like of a vehicle); and I/O active safety devices (e.g., seat belt sensors, seat belt retractors, airbags, and the like of a vehicle).

Thus, as configured in FIG. 1, the operations of the connected compute center 110, the backbone 130, the zone I/O controllers 140, and the I/O devices (e.g., the system 100 and elements therein) are necessarily rooted in the computational ability of the processor 111 and/or the system memory 112 to overcome and address the herein-described shortcomings of the conventional automotive electrical architectures. In this regard, the system 100 provides a component based approach that supports multiple domains and functions through zone gateways (thereby increasing system efficiency, providing wiring reduction, reduced system complexity, and reducing time-to-market for the vehicle).

Turning now to FIG. 2, a process flow 200 is depicted in accordance with one or more embodiments. The process flow 200 is an example zone controlling of features and functions of a vehicle by the system 100. The process flow 200 begins at block 220, where the backbone 130 (which is communicatively coupled to the connected compute center 110 and one or more of the zone I/O controllers 140) communicates inputs and outputs with respect to the features and functions (represented by dashed-block 150 in FIG. 1).

At block 240, the connected compute center 110 hosts processing operations that control the features and the functions of the vehicle based on the inputs and outputs, which were communicated via the backbone 130.

At block 260, the zone I/O controllers 140 distribute the inputs and outputs to and from the features and the functions of the vehicle. The features and the functions (e.g., the I/O devices) are distributed throughout the vehicle and connected to the zone I/O controllers 140 based on being located in a (specific/particular) region of the vehicle and local to a particular zone I/O controller 140.

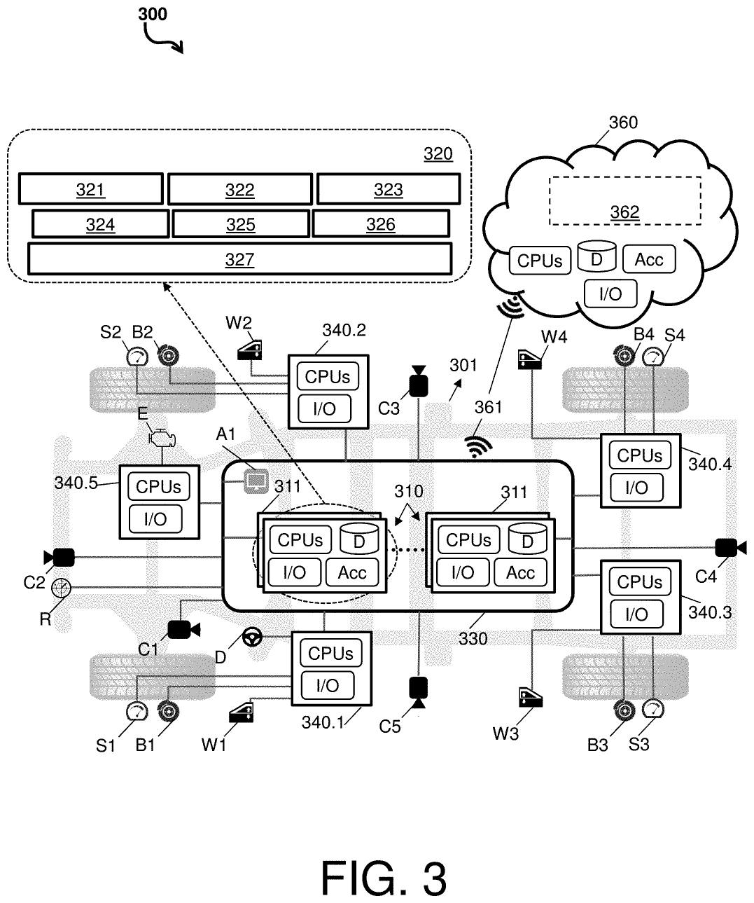

FIG. 3 depicts an architecture 300 in accordance with one or more embodiments. The architecture 300 can be an electronic, computer framework comprising and/or employing any number and combination of computing devices and networks utilizing various communication technologies, as described herein. The architecture 300 can be easily scalable, extensible, and modular, with the ability to change to different services or reconfigure some features independently of others. In accordance with one or more embodiments, the architecture 300 is implemented across a vehicle 301, which is silhouetted behind the architecture 300 in the figure.

In general, the architecture 300 provides electrical and software architecture for vehicle applications, leveraging modern wired/wireless communication and embedded/cloud computing technologies. As shown in FIG. 3, the architecture 300 includes a connected compute center 310, which includes a plurality of compute modules 311 further including processors (identified by CPUs), interfaces (identified by I/O), accelerators (identified by Acc), and a database (identified by D). Each compute module 311 can further support, for example, a virtual platform 320 with multiple applications 321, 322, 323, partitions, 324, 325, 326, and a mixed criticality/mixed operating system (OS) 327.

The architecture 300 includes an Ethernet backbone 330 including a network infrastructure including wired and wireless connection mediums that support communications between the connected compute center 310 and a plurality of zone modules 340 of the architecture 300 (e.g., the Ethernet backbone 330 communicatively couples connected compute centers 310 and the plurality of zone modules 340). The Ethernet backbone 330 can be a one Gigabits per second network that enables seamless transmissions of I/Os around the architecture 300.

Note that, in accordance with one or more embodiments, five distinct zone modules 340.1, 340.2, 340.3, 340.4, and 340.5 are shown with respect to specific areas or regions of the vehicle 301. For example, the zone modules 340.1 can be located on a left-front region of the vehicle 301; the zone modules 340.2 can be located on a right-front region of the vehicle 301; the zone modules 340.3 can be located on a left-rear region of the vehicle 301; the zone modules 340.4 can be located on a left-rear region of the vehicle 301; and the zone modules 340.5 can be located on a front-center region of the vehicle 301. In this regard, I/O devices local to a particular one of the zone modules 340 are connected thereto (e.g., inputs and outputs are allocated to a closest zone module, instead of to specific microcontrollers per function/feature as in the conventional automotive electrical architectures). In turn, automotive functions and features execute on the connected compute center 310 and communicate with zone modules 340 via the Ethernet backbone 330.

For instance, a speed sensor S1, a brake actuator B1, and a window sensor W1 are I/O devices connected to the zone module 340.1, along with the I/O device of a steering column sensor D. Further, a speed sensor S2, a brake actuator B2, and a window sensor W2 are I/O devices connected to the zone module 340.2; a speed sensor S3, a brake actuator B3, and a window sensor W3 are I/O devices connected to the zone module 340.3; and a speed sensor S4, a brake actuator B4, and a window sensor W4 are I/O devices connected to the zone module 340.4. In addition, an engine sensor E is an I/O device connected to a zone module 340.5, while a radar sensor R and cameras C1, C2, C3, C4, and C5 are I/O devices connected directly to the Ethernet backbone 330.

The architecture 300 also includes a cloud service 360, which includes processors (identified by CPUs), interfaces (identified by I/O), accelerators (identified by Acc), and a database (identified by D). The cloud service 360 connects wirelessly 361 to the connected compute center 310 to provide remote compute resources for offloading certain functions from the vehicle 301. That is, the architecture 300 can exploit vehicle connectivity to offload applications that traditionally run on an embedded microprocessor. Further, the architecture 300 can determine and evaluate latency requirements when making a decision as to whether or not a vehicle function or feature shall execute in the cloud. The technical effects and benefits of this offloading include enabling for simpler management than conventional automotive electrical architectures, reduced on-board computing requirements, flexibility, and reduced time-to-market of new features.

The cloud service 360 can provide a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may be deployed as a Software-as-a-Service (SaaS), a Platform-as-a-Service (PaaS), or an Infrastructure-as-a-Service (IaaS).

Turning now to FIG. 4, a process flow 400 is depicted in accordance with one or more embodiments. The process flow 400 is an example zone controlling of features and functions of the vehicle 301 by the architecture 300. The process flow 400 begins at block 410, where the architecture 300 reads data (outputs) with respect to one or more I/O devices. For instance, the connected compute center 310 directly reads front radar data from the radar sensor R via the Ethernet backbone 330, while the zone module 340.1 reads tire speed data from the speed sensor S1.

At block 420, the architecture 300 executes diagnostics and packaging of the data to produce packaged data. Based on which element of the architecture 300 reads the data, that element can perform the diagnostics and packaging. For instance, after the zone module 340.3 reads tire speed data from the speed sensor S3, the zone module 340.3 can diagnose and package the tire speed data so that it can be sent across the Ethernet backbone. At block 430, the architecture 300 forwards, through the Ethernet backbone 330, the packaged data. Note that if the connected compute center 310 directly reads data from an I/O device, block 430 may be merged with blocks 410 and 420 and/or the packaging of the data may be avoided.

At block 440, the connected compute center 310 executes zone controlling to determine process actions and render corresponding packaged outputs. That is, in response to receiving the packaged data, the connected compute center executes one or more of the applications 321, 322, and 333 of the virtual platform 320 to drive decision on operating the I/O devices of the architecture 300. The decisions themselves are implemented as commands or instructions, which are rendered as the packaged outputs. At block 450, the architecture 300 forwards, through the Ethernet backbone 330, the packaged outputs. At block 460, architecture 300 executes diagnostics and un-packaging of the packaged outputs to render outputs.

For instance, after the zone module 340.3 reads commands or instructions from the connected compute center 310 for the braking actuator B3, the zone module 340.3 forwards an instruction to drive the braking actuator B3 as an output. At block 470, the I/O device implements the outputs received from the other items of the architecture 300.

If the connected compute center 310 directly provides outputs to an I/O device, blocks 440 and 450 may be merged and/or the un-packaging of the commands or instructions may be avoided. Note that blocks 420 and 460 can be viewed as sub-operations of block 260 of FIG. 2, blocks 430 and 450 can be viewed as sub-operations of block 220 of FIG. 2, and block 440 can be viewed as sub-operations of block 240 of FIG. 2.

Embodiments herein may be a system, a method, and/or a computer program product at any possible technical detail level of integration. The computer program product may include a computer readable storage medium (or media) having computer readable program instructions thereon for causing a processor to carry out aspects of the embodiments herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc (CD) ROM, a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments herein.

Aspects of the embodiments herein are described with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the disclosure herein has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of zone controlling of features and functions of a vehicle, the method comprising:
communicating, via a backbone communicatively coupling a connected compute center and one or more zone modules, inputs and outputs with respect to the features and the functions;
hosting, by the connected compute center, processing operations that control the features and the functions of the vehicle based on the inputs and outputs communicated via the backbone; and
distributing, by the one or more zone modules, the inputs and outputs to and from the features and the functions of the vehicle.

2. The method of claim 1, wherein the features and the functions comprise input/output (I/O) devices distributed throughout the vehicle and connected to the one or more zone modules based on a region of the vehicle.

3. The method of claim 1, wherein the one or more zone modules support different domains of the features and the functions.

4. The method of claim 1, wherein the connected compute center executes a virtual platform comprising one or more virtual machines that operate the features and the functions of the vehicle by driving the inputs and outputs across the backbone and through the one or more zone modules.

5. The method of claim 1, wherein the backbone comprises an Ethernet backbone providing local area and wide area network capabilities for communicating the inputs and the outputs between at least the connected compute center and the one or more zone modules.

6. The method of claim 1, wherein the connected compute center is communicatively coupled to a cloud service where certain functions are offloaded from the connected compute center to remote compute resources therein.

7. The method of claim 1, wherein the features and the functions include transducers, lights, light emitting diodes, or speakers.

8. A system providing zone control of features and functions of a vehicle, the system comprising:
one or more zone modules;
a connected compute center; and
a backbone communicatively coupled to the connected compute center and the one or more zone modules,
wherein the backbone communicates inputs and outputs with respect to the features and the functions;
wherein the connected compute center hosts processing operations that control the features and the functions of the vehicle based on the inputs and outputs communicated via the backbone; and
wherein the one or more zone modules distribute the inputs and outputs to and from the features and the functions of the vehicle.

9. The system of claim 8, wherein the features and the functions comprise input/output devices distributed throughout the vehicle and connected to the one or more zone modules based on a region of the vehicle.

10. The system of claim 8, wherein the one or more zone modules support different domains of the features and the functions.

11. The system of claim 8, wherein the connected compute center executes a virtual platform comprising one or more virtual machines that operate the features and the functions of the vehicle by driving the inputs and outputs across the backbone and through the one or more zone modules.

12. The system of claim 8, wherein the backbone comprises an Ethernet backbone providing local area and wide area network capabilities for communicating the inputs and the outputs between at least the connected compute center and the one or more zone modules.

13. The system of claim 8, wherein the connected compute center is communicatively coupled to a cloud service where certain functions are offloaded from the connected compute center to remote compute resources therein.

14. The system of claim 8, wherein the features and the functions include transducers, lights, light emitting diodes, or speakers.

15. A vehicle providing zone control of features and functions, the vehicle comprising:
one or more zone modules;
a connected compute center; and
a backbone communicatively coupled to the connected compute center and the one or more zone modules,
wherein the backbone communicates inputs and outputs with respect to the features and the functions;
wherein the connected compute center hosts processing operations that control the features and the functions of the vehicle based on the inputs and outputs communicated via the backbone; and
wherein the one or more zone modules distribute the inputs and outputs to and from the features and the functions of the vehicle.

16. The vehicle of claim 15, wherein the features and the functions comprise input/output devices distributed throughout the vehicle and connected to the one or more zone modules based on a region of the vehicle.

17. The vehicle of claim 15, wherein the one or more zone modules support different domains of the features and the functions.

18. The vehicle of claim 15, wherein the connected compute center executes a virtual platform comprising one or more virtual machines that operate the features and the functions of the vehicle by driving the inputs and outputs across the backbone and through the one or more zone modules.

19. The vehicle of claim 15, wherein the backbone comprises an Ethernet backbone providing local area and wide area network capabilities for communicating the inputs and the outputs between at least the connected compute center and the one or more zone modules.

20. The vehicle of claim 15, wherein the connected compute center is communicatively coupled to a cloud service where certain functions are offloaded from the connected compute center to remote compute resources therein.
